(19) United States
(12) Patent Application Publication
(10) Pub. No.: US 2017/0331716 A1
(43) Pub. Date: Nov. 16, 2017

(54) ACTIVE PROBING FOR TROUBLESHOOTING LINKS AND DEVICES

(71) Applicant: Microsoft Technology Licensing, LLC, Redmond, WA (US)

(72) Inventors: Haitao Wu, Sammamish, WA (US); Shalabh Jain, Redmond, WA (US); Pradeepkumar Mani, Issaquah, WA (US); Chuanxiong Guo, Bellevue, WA (US); Marina Lipshteyn, Bellevue, WA (US); David Aaron Maltz, Bellevue, WA (US)

(21) Appl. No.: 15/353,523

(22) Filed: Nov. 16, 2016

Related U.S. Application Data
(60) Provisional application No. 62/334,285, filed on May 10, 2016.

(51) Int. Cl. H04L 12/26; H04L 12/46

(52) U.S. Cl. CPC H04L 43/10; H04L 43/0876; H04L 12/4633; H04L 43/0829

(57) ABSTRACT

Securely storing assets in a cloud computer storage service. Preparation to store assets for a user may comprise determining a location to store the assets, generating a write access signature, and sending the determined location and the signature to the user. A request is received from the user to store the assets. Such a request includes the assets, the location, and the signature. In response to receiving the request, a determination is made regarding the write access signature whether the request should be honored. When the request is honored, the assets are stored in the determined location and the write access signature is invalidated. Upon subsequent user requests to access the assets, short-term read access signatures are generated and provided to the user. The assets are written once per generated write access signature and reads are to be performed close in time to when short-term read access signatures are requested.

### CROSS-REFERENCE TO RELATED APPLICATION

This application claims the benefit of U.S. Provisional Patent Application Ser. No. 62/334,285, filed May 10, 2016, which provisional patent application is incorporated herein by reference in its entirety.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For instance, cloud computer systems are increasingly popular. Such cloud computer systems may allow users to remotely store large amounts of data, access additional computing resources when desired, and so forth. Oftentimes, these cloud computer systems include large data center networks. For instance, data center networks may be constructed to interconnect hundreds, or even thousands, of servers. For better load balancing and fault tolerance, network infrastructure may be designed to provide multiple parallel paths between any two devices in a network. When devices or links within such a network are in binary status (i.e., working or not working), it may be relatively simple to identify the location of a problem.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to determining a loss rate of a link in a network by actively probing the network. For example, embodiments may include preparing a plurality of paths within the network. Each of the plurality of paths include at least one link, and each link within the network is traversed by at least two paths. Preparing the plurality of paths includes at least determining a number of hops associated with each path and each link. A predetermined number (or plurality) of packets is sent along each of the plurality of paths. A loss rate is then determined for at least one link included in the plurality of paths. Determining the raw loss rate for the at least one link includes at least identifying the number of hops associated with the at least one link, and identifying both a number of dropped packets and a number of sent packets for each path that traverses the link.

Tunnel encapsulation/decapsulation may be used in the preparation of paths/links in a network to control the actual path that a packet traverses in the network. As such, multiple paths with variable lengths may be constructed. The length of those paths may then be increased to measure the loss rate of all links included within a network in a “hop-by-hop” manner, even in cases where the loss rate is variable or less than 100%. Furthermore, in circumstances where not all switches in a network support tunnel encapsulation/decapsulation, loss measurement results from multiple parallel paths that traverse a particular link may be aggregated to accurately deduce a loss/drop rate of the particular link. Finally, by preprocessing all the dead links initially (i.e., removing all dead links before performing any other processing), the impact of dead links may be at least partially mitigated.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment of a data center network.

FIG. 3 illustrates another example environment of a data center network having a “path n” and a “path (n+1)”.

FIG. 4 illustrates another example environment of a data center network that allows for determining a loss rate measured by multiple parallel paths.

FIG. 5 illustrates a flow chart of an example method for determining a loss rate of a link (n+1).

FIG. 6 illustrates an example environment for a data center network in which one or more network devices are incapable of performing encapsulation/decapsulation with respect to packets.

FIG. 7 illustrates a flow chart of an example method for determining a link loss rate, despite one or more network devices being incapable of performing encapsulation/decapsulation.

FIG. 8 illustrates a flow chart of an example method for determining a loss rate of a link in a network by actively probing the network.

### DETAILED DESCRIPTION

At least some embodiments described herein relate to determining a loss rate of a link in a network by actively probing the network. For example, embodiments may include preparing a plurality of paths within the network. Each of the plurality of paths include at least one link, and each link within the network is traversed by at least two paths. Preparing the plurality of paths includes at least determining a number of hops associated with each path and each link. A plurality of packets is sent along each of the plurality of paths. A loss rate is then determined for at least one link included in the plurality of paths. Determining the raw loss rate for the at least one link includes at least identifying the number of hops associated with the at least one link, and identifying both a number of dropped packets and a number of sent packets for each path that traverses the link.

Tunnel encapsulation/decapsulation may be used in the preparation of paths/links in a network to control the actual path that a packet traverses in the network. As such, multiple paths with variable lengths may be constructed. The length of those paths may then be increased to measure the loss rate of all links included within a network in a “hop-by-hop” manner, even in cases where the loss rate is variable or less than 100%. Furthermore, in circumstances where not all switches in a network support tunnel encapsulation/decapsulation, loss measurement results from multiple parallel paths that traverse a particular link may be aggregated to accurately deduce a loss/drop rate of the particular link. Finally, by preprocessing all the dead links initially (i.e., removing all dead links before performing any other processing), the impact of dead links may be at least partially mitigated.

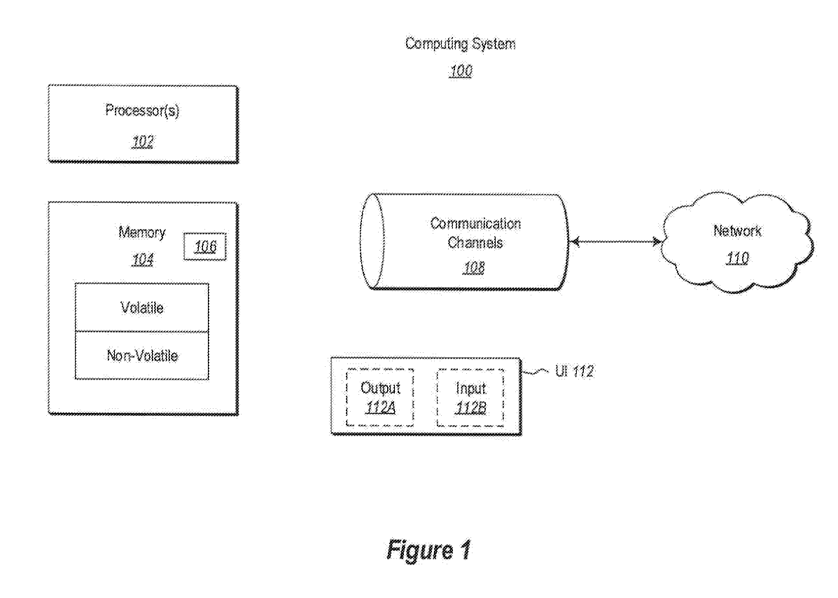

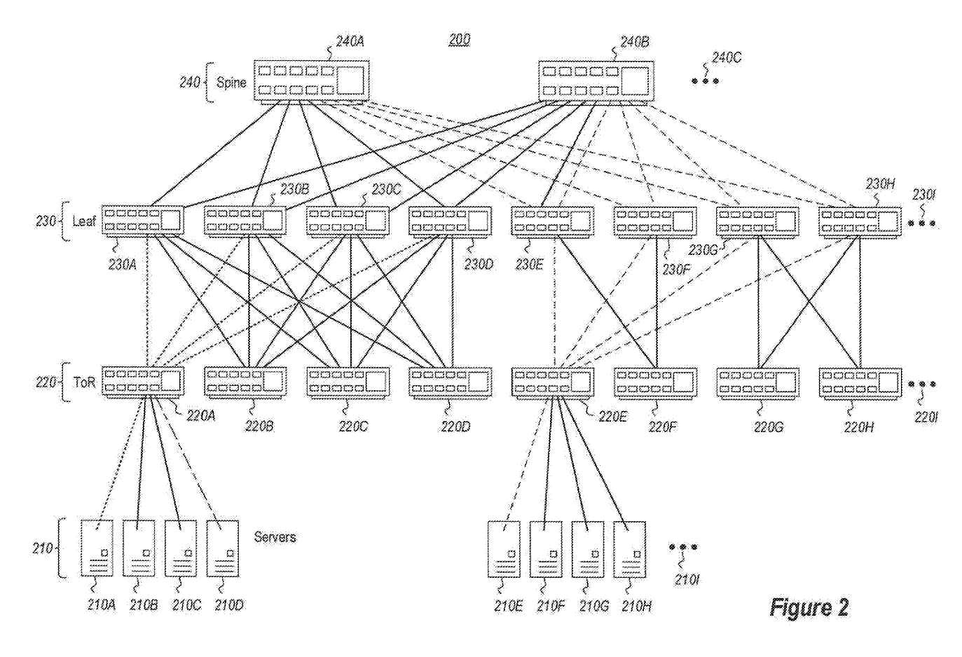

Some introductory discussion of a computing system will be described with respect to FIG. 1. Then determining a loss rate of a link in a network by actively probing the network will be described with respect to FIGS. 2 through 8.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an example environment for a datacenter network 200. More specifically, FIG. 2 shows a simplified fat-tree topology for a datacenter network 200. As illustrated, there are three layers of switches in the fat-tree topology. From bottom-to-top, they are Top-of-Rack (TOR) switches 220, leaf switches 230, and spine switches 240. FIG. 2 also includes multiple servers 210 (i.e., server 210A through server 210H) that are each connected to a TOR switch 220 (i.e., TOR switch 220A through TOR switch 220H). While only eight servers 210 and eight TOR switches 220 are shown, ellipses 2101 and ellipses 2201 illustrate that there may be any number of servers 210 and TOR switches 220 included within network 200.

As shown, each TOR switch 220 is connected to a higher layer leaf switch 230 (i.e., leaf switch 230A through leaf switch 230H), and each leaf switch 230 is connected to a higher layer spine switch 240 (i.e., spine switch 240A and spine switch 240B). While only eight leaf switches 230 and two spine switches 240 are shown, ellipses 2301 and ellipses 240C illustrate that there may network 200 may include any number of leaf switches 230 and spine switches 240, respectively. Each of these connections (e.g., server 210D to TOR switch 220A) form what is referred to herein as a link.

As briefly mentioned, while only a relatively small number of devices (e.g., servers, TOR switches, and so forth) within the datacenter network 200 are shown in FIG. 2, data center networks may be constructed to interconnect hundreds, or even thousands, of servers and devices. For better load balancing and fault tolerance, the network infrastructure may be designed to provide multiple parallel paths between two devices in a network, as further described herein. Parallel paths within a datacenter network may be supported on commodity switches by using Equal Cost Multi-Path (ECMP) routing. Depending on the scale of the structure, there may be multiple levels within a network that use ECMP simultaneously. Generally, ECMP comprises a hash function for a packet header, such that packets belonging to the same connection are expected to traverse the same path.

Multiple parallel paths between any end points may at least partially be used and designed to scale out a given structure. However, when there are link failures or congestion points, a path that has an unhealthy link may be hard to differentiate from healthy links and/or paths. The difficulty in differentiating may arise from the fact that it can be difficult to determine which path a packet has used based on the content of the packet header. Additionally, if the network devices or links are in binary status (i.e., working or not working), then it may be relatively easy to identify the location of a problem. However, if a link or device drops packets with a probability or pattern, instead of all or nothing, then it may be difficult to identify the unhealthy/misbehaved links/devices.

In response to such issues, novel uses of active probing may be used to measure a loss rate for any particular link (i.e., connection between two devices in a network), as further described herein. A packet with a controlled path may be referred to as a probe. For instance, tunnel encapsulation and/or decapsulation of packets may be used to control the exact path that a packet traverses. Tunnel encapsulation may comprise wrapping an entire packet into the payload of another packet. The packet being encapsulated may be referred to as an inner-packet, and the packet header that wraps the encapsulated packet may be referred to as an outer packet header. Tunnel decapsulation may comprise the reverse process (i.e., removing the outer packet header and treating the inner-packet as a new packet to forward as needed). Many tunnel protocols have been standardized (e.g., IP-in-IP, GRE, MPLS, and so forth), any of which may be used with principles described herein. Raw data may then be obtained by sending a certain number of probes along a path and measuring how many packets returned. The gathered raw data may then be used to deduce the loss rate for each link/path in a network.

Active probing may be used either as a proactive service that probes the network with a reasonable time granularity, or as a tool that can be used on-demand to check a run-time network status. By using encapsulation/decapsulation of data packets (e.g., via hardware on switches), paths that packets traverse in a network can be closely or loosely controlled. As such, the link loss rate may be measured and deduced in a “hop-by-hop” manner, as described more fully herein. By integrating the measurement results from multiple servers in the network, a full picture for the status of links and devices in a datacenter network may be constructed.

As previously discussed, numerous problems may arise while attempting to gather this raw data using probes. For instance, while most unhealthy links simply drop all packets attempting to traverse a given unhealthy link, other links may drop packets at a certain rate or with a particular pattern. More specifically, links may only drop packets having a random ratio, or based on a field of an IP header (e.g., 5-tuple, which is used to identify a connection for ECMP load hashing). Accordingly, a method to calculate a loss rate for each link may be utilized (i.e., to quantify how unhealthy a link is).

As such, FIG. 2 further illustrates a “hop-by-hop” probing scheme using different types of lines to highlight various paths. Instead of using a probe to cover the links for a path, multiple paths that each have a different hop number may be used. For example, there is one path that has only one hop (i.e., a one hop path), which begins at server 210D and ends at TOR switch 220A. The one hop path is further shown by a a dashed-line that includes longer lines followed by shorter lines (i.e., long line, short line, long line, short line, and so forth). Furthermore, there are four paths having two hops (i.e., two hop paths), which begin at server 210A and end at each of leaf switches 230A through 230D. Each of the four two hop paths are further shown by the smallest dashed-line (i.e., the line having small, equally-sized lines that together create the entirety of the dashed line). Still further, there are four paths having three hops (i.e., three hop paths), which begin at server 210E and end at either spine switch 240A or spine switch 240B. The four three hop paths are further shown by the larger dashed-lines (i.e., longer equally-sized dashed-lines than those associated with the two hop paths). Paths/links shown by the regular line (i.e., having no dashes of any kind) simply illustrate an example topology of the network, including other paths/links that may be included in datacenter network 200.

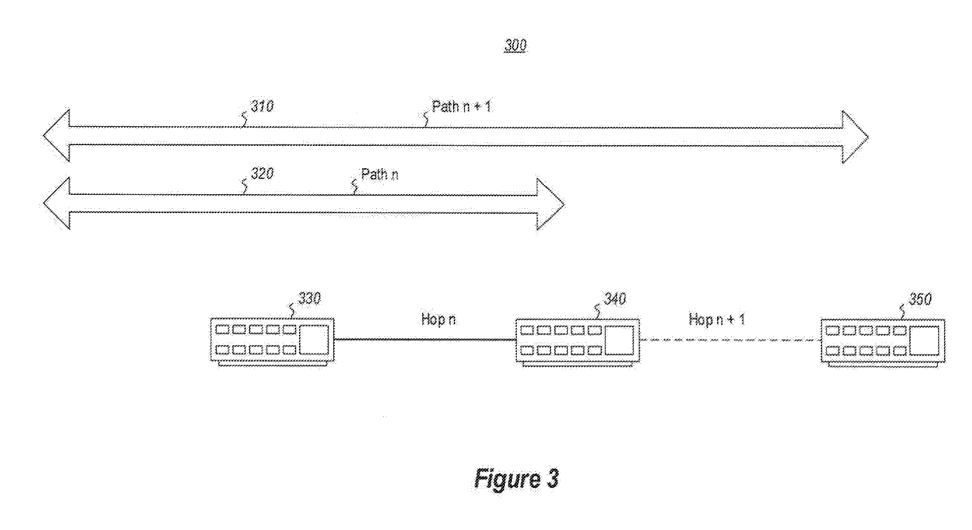

As illustrated in FIG. 2, all the paths travel from the bottom up, so there is no need for paths that travel up and down. For example, in order for server 210A to reach server 210D, the network path can be presented as server 210A to TOR switch 220A to server 210D, which is two hops. This type of path may be avoided with respect to active probing, as two one hop paths may be used to cover all the links in the described path (i.e., the paths covered by server 210A to TOR switch 220A and server 210D to TOR switch 220A). Accordingly, active probing covers both forward and backward direction (i.e., the links are bidirectional), as described herein. Once the paths have been defined, probes may be generated for each defined path. Based on the results of paths with increasing hop numbers, the loss rate of each hop may be determined, as illustrated and described with respect to FIG. 3.

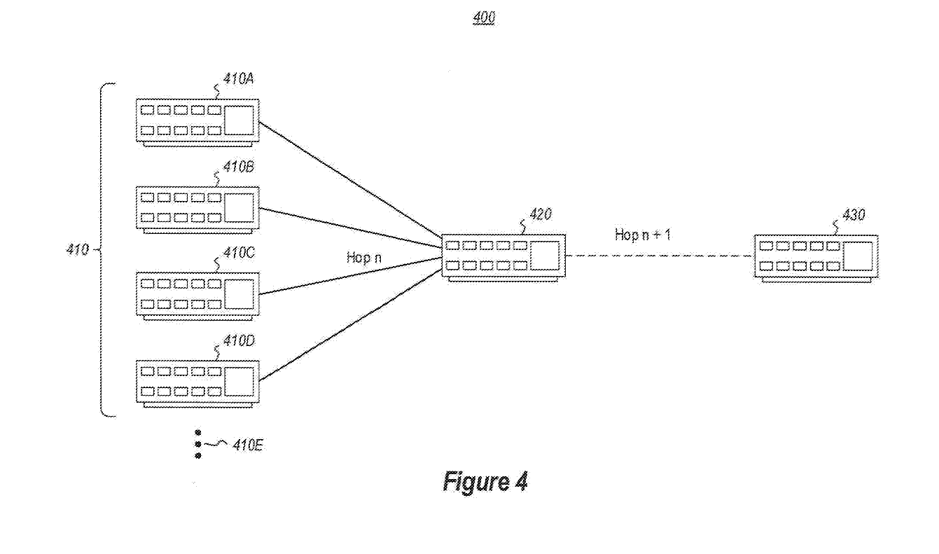

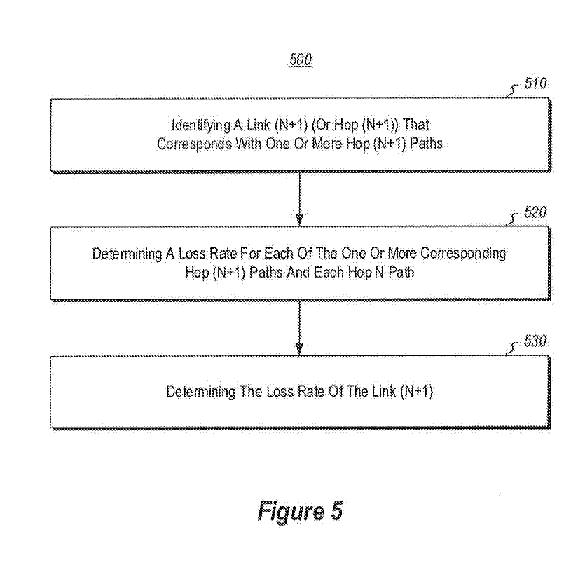

FIG. 3 includes a “path n” illustrated by arrow 320 that represents a path from device 330 to device 340. FIG. 3 also includes a “path (n+1)” illustrated by arrow 310 that represents a path from device 330 to device 350. As such, suppose the loss rate of path n, as represented by “p(n)”, has been obtained. Additionally, suppose that a loss rate of path (n+1), as represented by “p(n+1)”, has been obtained. Assume that the goal is to calculate the loss rate of a “link (n+1)” (i.e., the link between device 340 and device 350), as represented by “1(n)”. Also, assume that when measuring path (n+1), the first n hops have the same loss rate as measured with respect to path n, then 1−p(n+1)=(1−p(n))(1−1(n)). When p(n) and p(n+1) are small, the previous equation may be simplified as 1(n)=p(n+1)−p(n) (i.e., subtracting the loss rate of path n from the loss rate of path (n+1)). As such, that equation may work well when the loss rate is small, however, the fact that for each node, there are multiple paths traversing the node, may be leveraged. Accordingly, instead of relying on the loss rate measured by one path, the average loss rate measured by multiple paths simultaneously, may be used, as illustrated by FIG. 4 and FIG. 5.

FIG. 4 includes devices 410 (device 410A through device 410D) that can each be used to traverse parallel paths that include the link between device 420 and device 430 (i.e., link (n+1)). While only four devices 410 are shown, ellipses 410E illustrate that the principles described herein relating to FIG. 4 may include any number of devices 410. As shown, each path from a device 410 to device 420 is considered as “hop n” (or path n). Likewise, each path that begins at a device 410 and ends at device 430 may be considered as a “hop (n+1)” path (or path (n+1)). Additionally, the connection between device 420 and device 430 may be considered as link (n+1).

FIG. 5 illustrates a method 500 for determining a loss rate of a link (n+1). More specifically, FIG. 5 illustrates a typical case in which the loss rate of a link (n+1) can be deduced by measuring the loss rate of the one or more hop n paths and hop (n+1) paths associated that traverse the link (n+1). The method 500 is described with frequent reference to the network 400 of FIG. 4. The method 500 begins by identifying a link (n+1) (or hop (n+1)) that corresponds with one or more hop (n+1) paths (Act 510). Each of the one or more hop (n+1) paths corresponds with a hop n path (Act 510). For instance, network 400 of FIG. 4 illustrates a link (n+1) from device 420 to device 430. As illustrated, the link (n+1) includes four hop (n+1) paths (i.e., the paths from devices 410 to device 430). Similarly, the four hop (n+1) paths correspond to four hop n paths (i.e., the paths from devices 410 to device 420).

The method 500 further includes determining a loss rate for each of the one or more corresponding hop (n+1) paths and each hop n path (Act 520). Determining a loss rate for each hop (n+1) path and each hop n path may include sending a plurality of probes along each hop (n+1) path and each hop n path, and identifying the number of dropped packets along each hop (n+1) path and each hop n path. Notably, each hop n path corresponds to a hop (n+1) path. For instance, path n from device 410A to device 420 corresponds to path (n+1) from device 410A to device 430. In the continuing example, assume that 250 probes were sent along each path n and each path (n+1) (i.e., 1,000 packets total traversing all of the path n paths and 1,000 packets total traversing all of the path (n+1) paths). Also, assume that five packets were dropped along each path n, resulting in a total of 20 packets dropped. Additionally, assume that eight packets were dropped along each path (n+1) path, resulting in a total of 32 packets dropped. Accordingly, the loss rate of each path n is 2% (i.e., five dropped packets divided by 250 sent packets), and the loss rate of each path (n+1) is 3.2% (i.e., eight dropped packets divided by 250 sent packets).

The method 500 further includes determining the loss rate of the link (n+1) (Act 530). Determining the loss rate of the link (n+1) may include, for each particular hop (n+1) path, reducing both the number of packets sent along the particular hop (n+1) path by the number of packets dropped along the hop n path corresponding to the particular hop (n+1) path, as well as the number of packets dropped along the particular hop (n+1) path by the number of packets dropped along the hop n path corresponding to the particular hop (n+1) path. Accordingly, in the continuing example, the 8 packets dropped along each hop (n+1) path may be reduced by the five packets dropped along each hop n path, resulting in only three packets dropped per hop (n+1) path along link (n+1) (or 12 total packets dropped along link (n+1)).

Additionally, the 250 packets/probes sent per hop (n+1) path may be reduced by the five packets dropped along each path n, resulting in only 245 packets sent along each hop (n+1) path along link (n+1) (or 980 total packets sent along link (n+1). As such, the loss rate of link (n+1) may then be determined by dividing the total number of packets dropped by link (n+1), 12, by the total number of packets sent along link (n+1), 980, for a loss rate of approximately 1.2%. Notably, while the method 500 was described with respect to a specific network configuration having four paths, the method 500 may be used with any number of network configurations having any number of paths.

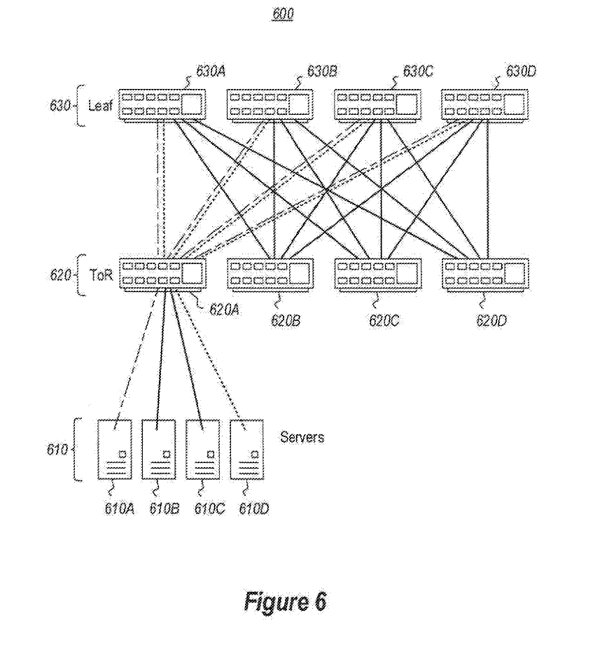

FIG. 6 illustrates an example environment 600 for a data center network in which one or more devices included within environment 600 are incapable of performing encapsulation/decapsulation with respect to packets. FIG. 6 includes two layers of switches, TOR switches 620 (i.e., TOR switch 620A through TOR switch 620D) and leaf switches 630 (i.e., leaf switch 630A through leaf switch 630D). FIG. 6 also includes multiple servers 610 (i.e., server 610A through server 610D) that are each connected to a TOR switch 620 (i.e., TOR switch 220A through TOR switch 220H). As shown, each TOR switch 620 is also connected to a higher layer leaf switch 630 (i.e., leaf switch 630A through leaf switch 630D).

As briefly mentioned, in some circumstances, less than all of the devices in a network may be able to support encapsulation/decapsulation at the same time. This may be caused because switches from different vendors may have differing architectures, and yet may still be used in the same network. Oftentimes, all switches in the same layer may be of the same type. Accordingly, none of the switches in a particular layer may be able to perform encapsulation/decapsulation (or alternatively, all of them may be able to perform encapsulation/decapsulation).

For instance, suppose all TOR switches 620 (i.e., TOR switch 620A through TOR switch 620D) are incapable of performing encapsulation/decapsulation with respect to packets that traverse the network 600. Paths may then be drawn that can be covered by server 610A and server 610D, shown by the dashed-line having longer lines followed by shorter lines (i.e., long line, short line, long line, short line, and so forth) and the small dashed-line (i.e., the dashed-line having small, equally-sized lines that create the entirety of the dashed-line), respectively. Because none of the TOR switches 620 are able to perform encapsulation/decapsulation, all paths require two hops (i.e., there is no one-hop path to any TOR switches 620). For example, for any link between server 610A and TOR switch 620A, there are four paths: 1) server 610A to TOR switch 620A to leaf switch 630A, 2) server 610A to TOR switch 620A to leaf switch 630B, 3) server 610A to TOR switch 620A to leaf switch 630C, and 4) server 610A to TOR switch 620A to leaf switch 630D. Four similar paths relating to the link between server 610D and TOR switch 620A are also illustrated by the small dashed-line (i.e., the dashed line having small, equally-sized lines that form the entirety of the line). Additionally, paths for every link between two devices within network 600 may also be prepared/identified.

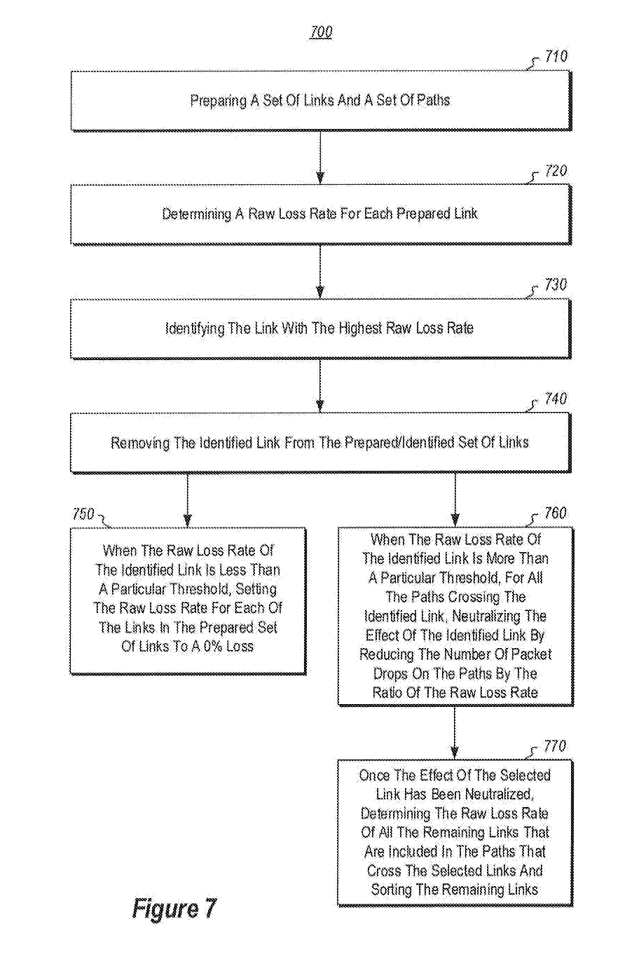

Accordingly, FIG. 7 illustrates a method 700 for determining a link loss rate, despite one or more devices (i.e., TOR switches 620) of network 600 being incapable of performing encapsulation/decapsulation. The method 700 will be described with frequent reference to the network 600 of FIG. 6. Additionally, while the method 700 is discussed within the context of a network 600 in which all switches in a layer are either capable or incapable of performing encapsulation/decapsulation, the method 700 may also work when only some switches within a particular layer of a network are not able to perform encapsulation/decapsulation.

The method 700 may begin by preparing a set of links and a set of paths (Act 710). For example, as previously, described, four paths may be prepared/identified in relation to the link between server 610A and the TOR switch 620A, as illustrated by the dashed-line having longer lines followed by shorter lines in FIG. 6. Similar paths may be prepared/identified for each link within network 600 (e.g., as illustrated by the small dashed-line having small, equally-sized lines that together created the entirety of the dashed-line in relation to the link between server 610D and TOR switch 620A). The method 700 further includes determining a raw loss rate for each prepared/identified link (Act 720). Determining the raw loss rate for each prepared/identified link may comprise calculating the raw loss rate of each link as the average loss rate of all paths crossing it (i.e., the total number of packets dropped along all parallel paths that traverse the link divided by the total number of packets sent across all parallel paths that traverse the link). Additionally, heuristics may be used in the determination of the raw loss rate for each link in a given network.

For instance, the raw loss rate of a link from server 610A to TOR switch 620A may be estimated by using the average of the loss rate of the previously described four paths (i.e., all four paths that include the link from server 610A to TOR switch 620A as illustrated by the dashed-line having longer lines followed by shorter lines). In a more specific example, assume that 1,000 packets were sent along each of the four paths that traverse the link from server 610A to TOR switch 620A (i.e., 4,000 packets total that traverse the selected link). Additionally, assume that 10 packets were dropped along the path that ends at leaf switch 630A, 20 packets were dropped along the path that ends at leaf switch 630B, 30 packets were dropped along the path that ends at leaf switch 630C, and 40 packets were dropped along the path that ends at leaf switch 630D.

Accordingly, along paths that traverse the link from server 610A to TOR switch 620A, 4,000 packets were sent and 100 packets were dropped, resulting in an average loss rate along the paths traversing the link of 2.5% (i.e., 100 total dropped packets divided by 4,000 total sent packets). As such, the raw loss rate of the link from server 610A to TOR switch 620A may be determined to be 2.5%. Notably, while the minimum of the loss rate of the four paths may be used, using the average may be more tolerant to noise when there are a limited number of probes per path.

The method 700 further includes identifying the link with the highest raw loss rate (Act 730). In the continuing example, assume that a loss rate was determined for each link included in network 600. Furthermore, assume that the determined loss rate of 2.5% of the link from server 610A to TOR switch 620A was identified as the having the highest raw loss rate of any link in the network 600. Once the link is identified/selected, the loss rate of the identified link may be set as the previously determined raw loss rate of 2.5%. The method further includes removing the identified link from the prepared/identified set of links (Act 740).

In circumstances where the raw loss rate of the identified link is less than a particular threshold (as further described herein), the raw loss rate for each of the links in the prepared/identified set of links may be set to a 0% loss, in which case the method 700 is complete (Act 750). If, on the other hand, the raw loss rate of the identified link is more than a particular threshold, then for all the paths crossing the identified link, the effect of the identified link may be neutralized by reducing the number of packet drops on the paths by the ratio of the raw loss rate (Act 760).

In the continuing example, consider that 1,000 packets were sent on each path that traverses the identified link (i.e., 4,000 packets total), 10 packets were dropped along the path that ends at leaf switch 630A, 20 packets were dropped along the path that ends at leaf switch 630B, 30 packets were dropped along the path that ends at leaf switch 630C, and 40 packets were dropped along the path that ends at leaf switch 630D. The effect of the identified link may then be neutralized by reducing the number of packets sent and packets dropped along each path by the ratio of the raw loss rate (i.e., 2.5%) of the identified link. Accordingly, because 1,000 packets were sent along each path, the ratio of the raw loss rate would predict that 25 packets would be dropped when traversing the identified link during traversal of each of the four paths.

Regarding the four paths of the continuing example, reducing the number of packets sent and packets dropped along each path by the ratio of the raw loss rate would result in the path that ends at leaf switch 630A having 975 packets sent (i.e., subtracting 25 packets dropped at the identified link from the 1,000 packets sent along this particular path) and 0 packets dropped (i.e., 25 dropped packets subtracted from 10 dropped packets is −15, but a negative number of drops is not possible), the path that ends at leaf switch 630B having 975 packets sent and 0 packets dropped, the path that ends at leaf switch 630C having 975 packets sent and 5 packets dropped, and the path that ends at leaf switch 630D having 975 packets sent and 15 packets dropped.

Once the effect of the selected link has been neutralized, the raw loss rate of all the remaining links that are included in the paths that cross the selected link may again be determined and sorted based on the determined loss rates (Act 770). In other words, the adjusted number of both packets sent and packets dropped along each path, after neutralizing the effect of the identified link, may allow for making a new determination of the loss rate of each of the remaining links. Such a determination may be performed for each remaining link by dividing the adjusted number of packets dropped by the adjusted number of packets sent along the path corresponding to each remaining link (e.g., the link from TOR switch 620A to leaf switch 630A corresponds to the path from server 610A to leaf switch 630A).

Accordingly, determining loss rates of the rest of the links included within the four paths considered in the continuing example results in the following: the link from TOR switch 620A to leaf switch 630 A has a loss rate of 0%, the link from TOR switch 620A to leaf switch 630B has a loss rate of 0%, the link from TOR switch 620A to leaf switch 630C has a loss rate of approximately 0.5%, and the link from TOR switch 620A to leaf switch 630D has a loss rate of approximately 1.5%. The method 700 may then be repeated until the largest loss rate of any prepared/identified link is below a particular determined threshold. In some embodiments, the threshold may be set as 0.1%. In other embodiments, the threshold may be set as 0.05%. In yet other embodiments, the threshold may be set at 0.2%. The method 700 may be used as an aggressive, or greedy, strategy to identify the link with the highest loss rate, and then neutralize that link's maximal effects on all the paths crossing it. Furthermore, while the method 700 was described with respect to a specific example that included only four paths and five links, the method 700 may be used with any number of paths and any number of links.

At times, when providing active probing as a service, some links in the network may be dead (i.e., links that are experiencing 100% packet loss). As such, all paths having a dead link may experience 100% loss. Furthermore, the existence of a dead link may significantly affect the results of method 500 and method 700. For example, when there is a dead link in one of the paths in the method 700, the path containing the dead link may have a much larger raw loss rate, even if the link itself does not drop any packets. If there is a dead link, the method 700 may not be able to neutralize the effect, as other links may also be dead. Similarly, with respect to the method 500, the results may be biased unless all the paths having a dead link are removed. Accordingly, a pre-processing stage may be utilized in both the method 500 and the method 700 that identifies all links having a 100% raw loss rate (i.e., dead links) and removes the dead links in a batch, at which point the method 500 and the method 700 may be applied.

Accordingly, the method 500 and the method 700 may be used to determine loss rates for each link in a data center network regardless of whether every device in the network is capable of performing encapsulation/decapsulation. Initially, however, all dead links may be removed before any processing occurs. The processing of paths/links, as described herein, may then be performed “hop-by-hop” starting with the smallest hop (e.g., a 1 hop path). The method 700 may then be used to process data (e.g., identify links with a highest loss rate and neutralize those links) with respect to any hop n path. The method 500 may then be used to determine the data (i.e., loss rate) with respect to any hop (n+1) path. Finally, the method 700 may then be used to process the determined data of the hop (n+1) paths. In some embodiments, however, when each device within a network is capable of encapsulation/decapsulation, the method 500 may be used to determine data for all links/paths in the network (rather than just the hop (n+1) paths).

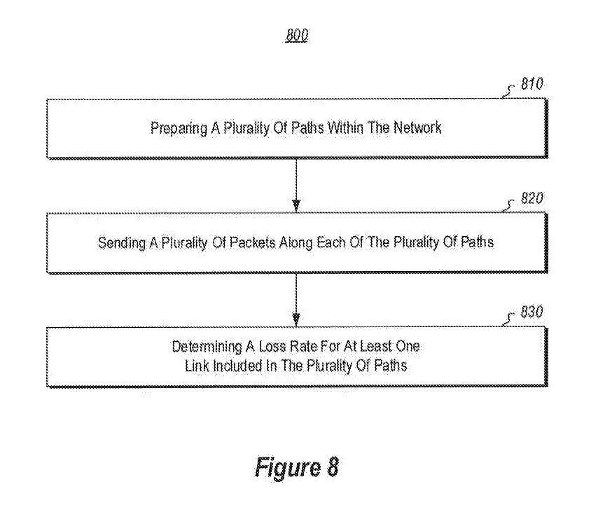

FIG. 8 is directed to a method 800 for determining a loss rate of a link in a network by actively probing the network. The method 800 includes preparing a plurality of paths within the network (Act 810). Each of the plurality of paths includes at least one link and each link within the network is traversed by at least two paths. Preparing the plurality of paths may include at least determining a number of hops associated with each path and each link (Act 810). For example, FIGS. 2 and 6 each illustrate a network having a plurality of prepared paths and links.

The method 800 includes sending a plurality of packets along each of the plurality of paths (Act 820). For example, a particular number of probes may be sent along each path of the network 200 or the network 600 of FIG. 2 and FIG. 6, respectively. The method 800 also includes determining a loss rate for at least one link included in the plurality of paths (Act 830). Determining the raw loss rate for the at least one link may include at least identifying the number of hops associated with the at least one link, and identifying both a number of dropped packets and a number of sent packets for each path that traverses the link. For instance, a loss rate for at least one link in a network may be obtained by using either the method 500 or the method 700, as described herein.

In this way, tunnel encapsulation/decapsulation may be used to control the actual path that a packet traverses in a network. As such, multiple paths with variable lengths may be constructed. The length of those paths may then be increased to measure the loss rate of all links included within a network in a “hop-by-hop” manner, even in cases where the loss rate is variable or less than 100%. Furthermore, in circumstances where not all switches in a network support tunnel encapsulation/decapsulation, loss measurement results from multiple parallel paths that traverse a particular link may be aggregated to accurately deduce a loss/drop rate of the particular link. Finally, by preprocessing all the dead links initially (i.e., removing all dead links before performing any other processing), the impact of dead links may be at least partially mitigated.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to determine a loss rate of a link in a network by actively probing the network, the computer-executable instructions including instructions that are executable to cause the computer system to perform at least the following:
prepare a plurality of paths within the network, each of the plurality of paths including at least one link, each link within the network being traversed by at least two paths, wherein preparing the plurality of paths includes at least determining a number of hops associated with each path and each link;
send a plurality of packets along each of the plurality of paths; and
determine a loss rate for at least one link included in the plurality of paths, wherein determining the raw loss rate for the at least one link includes at least:
identifying the number of hops associated with the at least one link; and
identifying both a number of dropped packets and a number of sent packets for each path that traverses the at least one link.

2. The computer system in accordance with claim 1, wherein the plurality of packets sent along each of the plurality of paths are encapsulated or decapsulated to thereby control which path a particular packet is to traverse within the network.

3. The computer system in accordance with claim 2, wherein at least one device in the network is incapable of performing encapsulation and decapsulation with respect to packets sent within the network.

4. The computer system in accordance with claim 3, wherein determining the loss rate of the at least one link also includes averaging the loss rate of all paths that cross the at least one link.

5. The computer system in accordance with claim 1, wherein at least one device of a layer of the network is incapable of performing encapsulation and decapsulation with respect to packets.

6. The computer system in accordance with claim 1, wherein the at least one link comprises a hop (n+1) link, the hop (n+1) link corresponding to one or more hop (n+1) paths, the one or more hop (n+1) paths each corresponding to a hop n path.

7. The computer system in accordance with claim 6, wherein determining the loss rate of the hop (n+1) link also includes, for each particular hop (n+1) path, at least:
reducing a number of packets sent along the particular hop (n+1) path by a number of packets dropped along the hop n path corresponding to the particular hop (n+1) path; and
reducing a number of packets dropped along the particular path (n+1) by the number of packets dropped along the hop n path corresponding to the particular hop (n+1) path.

8. The computer system in accordance with claim 1, wherein all links having a 100% loss rate are identified and removed before preparing the plurality of paths.

9. A method, implemented at a computer system that includes one or more processors, for determining a loss rate of a link in a network by actively probing the network, comprising:
preparing a plurality of paths within the network, each of the plurality of paths including at least one link, each link within the network being traversed by at least two paths, wherein preparing the plurality of paths includes at least determining a number of hops associated with each path and each link;
sending a plurality of packets along each of the plurality of paths; and
determining a loss rate for at least one link included in the plurality of paths, wherein determining the raw loss rate for the at least one link includes at least:
identifying the number of hops associated with the at least one link; and
identifying both a number of dropped packets and a number of sent packets for each path that traverses the link.

10. The method in accordance with claim 9, further comprising encapsulating or decapsulating the plurality of packets sent along each of the plurality of paths to thereby control which path a particular packet is to traverse within the network.

11. The method in accordance with claim 10, wherein at least one device in the network is incapable of performing encapsulation and decapsulation with respect to packets sent within the network.

12. The method in accordance with claim 11, wherein determining the loss rate of the at least one link also includes averaging the loss rate of all paths that traverse the at least one link.

13. The method in accordance with claim 12, further comprising identifying a link of the at least one link with a highest loss rate.

14. The method in accordance with claim 13, further comprising removing the link with the highest loss rate from the prepared plurality of paths within the network.

15. The method in accordance with claim 14, further comprising neutralizing an effect of the link with the highest loss rate by reducing a number of packets dropped along all paths that traverse the link with the highest loss rate by a ratio of the loss rate of the link with the highest loss rate.

16. The method in accordance with claim 9, wherein all devices of a layer of the network are capable of performing encapsulation and decapsulation with respect to packets.

17. The method in accordance with claim 16, wherein the at least one link comprises a hop (n+1) link, the hop (n+1) link corresponding to one or more hop (n+1) paths, the one or more hop (n+1) paths each corresponding to a hop n path.

18. The method in accordance with claim 17, wherein determining the loss rate of the hop (n+1) link also includes, for each particular hop (n+1) path, at least:
reducing a number of packets sent along the particular hop (n+1) path by a number of packets dropped along the hop n path corresponding to the particular hop (n+1) path; and
reducing a number of packets dropped along the particular path (n+1) by the number of packets dropped along the hop n path corresponding to the particular hop (n+1) path.

19. The method in accordance with claim 9, further comprising identifying and removing all links having a 100% loss rate before preparing the plurality of paths.

20. A computer program product comprising one or more hardware storage devices having stored thereon computer-executable instructions that are executable by one or more processors of a computer system to determine a loss rate of a link in a network by actively probing the network, the computer-executable instructions including instructions that are executable to cause the computer system to perform at least the following:
system to determine a loss rate of a link in a network by actively probing the network, the computer-executable instructions including instructions that are executable to cause the computer system to perform at least the following:
prepare a plurality of paths within the network, each of the plurality of paths including at least one link, each link within the network being traversed by at least two paths, wherein preparing the plurality of paths includes at least determining a number of hops associated with each path and each link;
send a plurality number of packets along each of the plurality of paths; and
determine a loss rate for at least one link included in the plurality of paths, wherein determining the raw loss rate for the at least one link includes at least:
identifying the number of hops associated with the at least one link; and
identifying both a number of dropped packets and a number of sent packets for each path that traverses the at least one link.
